(19) United States
(12) Patent Application Publication
(10) Pub. No.: US 2010/0318808 A1
(43) Pub. Date: Dec. 16, 2010

(54) METHOD AND A SYSTEM FOR THE CUSTOMISATION OF SMART OBJECTS

(75) Inventors: Benoit Berthe, Orleans (FR); Patrick Baudron, Boigny sur Bionne (FR); Frederic Beulet, Meung sur Loire (FR); Dominique Perdoux, Mardie (FR); Francois Drisse, Mennecy (FR)

Correspondence Address: HAMRE, SCHUMANN, MUELLER & LARSON, P.C., P.O. BOX 2902, MINNEAPOLIS, MN, 55402-0902, US

(73) Assignee: DATACARD CORPORATION, Minnetonka, MN (US)

(21) Appl. No.: 12/742,116

(22) PCT Filed: Nov. 12, 2008
(86) PCT No.: PCT/IB08/03043

§ 371 Date: Aug. 27, 2010

(30) Foreign Application Priority Data
Nov. 12, 2007 (FR) 07/07954

(51) Int. Cl. G06F 12/00; G06F 12/14

(52) U.S. Cl. 713/189; 711/154; 711/E12.001

(57) ABSTRACT

This present invention concerns a customization method that represents a saving in time and an increase in yield, in the electronic customization of smart objects in particular, by virtue of:—a stage for establishing communication links between a multiplicity of smart objects held on a portable support, and communication interfaces,—a stage for simultaneous unlocking of the smart objects by means of a first key,—a stage for the parallel transfer into the memory of the smart objects of customization data proper to each of the smart objects, with these data being transferred into at least one memory zone of each smart object,—a stage for the locking of each smart object by means of second keys, each proper to one of the smart objects and each associated with the customization data proper to this object.

The invention concerns the area of customisation machines. This present invention more particularly concerns a method and a system for the electronic customisation of smart objects or objects that contain integrated circuits or chips.

There exist test machines that include trays, on each of which are arranged integrated circuits, such as microprocessors, to be tested in these test machines. These test machines are generally equipped with a manipulator that removes the integrated circuits and transports them to a test position fitted with pins that make contact with the contact pads of the integrated circuits. Tests that include the application of voltages or of currents, or the measurement of impedances, are generally performed in order to confirm the functionality of each integrated circuit. However, the machines for the testing of integrated circuits on trays do not allow the customisation of intelligent smart objects that include a microprocessor and a memory to which access is protected by the microprocessor, at least in the case of certain secured zones, where these secured zones contain confidential and secret information that are used in the authentication process.

In order to personalise portable objects, and to write the confidential codes used for the authentication procedures into the protected memory areas, one has been familiar up to the present with customisation machines with a rotating drum that includes, at its periphery, a multiplicity of customisation stations that are loaded sequentially and successively with a programmable smart object. Each of the stations generally performs a full rotation after it has been loaded, with the electronic customisation being effected during this rotation. Each customisation station is then successively unloaded and reloaded with a new programmable smart object. In order to raise the capacity of these machines, and to improve productivity, it is necessary to increase the number of customisation stations, which at the same time increases the dimensions of the customisation machine. The size of the drum supporting the customisation stations is limited, for example, to a maximum diameter and a maximum number of stations corresponding to the maximum bulk.

The purpose of this present invention is to overcome one or more drawbacks of the prior art, by creating a high-speed customisation method that results in an increase in the capacity for electronic customisation of smart objects, but without increasing its dimensions and its bulk.

This objective is attained by virtue of a customisation method that is characterised in that it includes at least the following:
a stage for location or marking and identification of each of a multiplicity of smart objects received by a support;
a stage for centring each smart object in the support;
a stage for establishing communication links between a multiplicity of smart objects received by a support that is held in position in relation to a multiplicity of controlled connecting heads, according to at least one communication protocol determined by at least one electronic encoding device,
a stage for the parallel transfer into the memory of each of the multiplicity of smart objects, in accordance with the associated location or marking and identification, of customisation data proper to each of the smart objects, where these customisation data come from the memory of the said electronic encoding device and are transferred into at least one memory zone of each smart object,

According to another particular feature, the stage for the parallel transfer into the memory of each of the multiplicity of smart objects is preceded by a stage for simultaneous unlocking device, by means of at least one first key.

According to another feature, the stage for the parallel transfer into the memory of each of the multiplicity of smart objects is followed by a stage for the locking of each smart object by the said electronic encoding device, by means of second keys, each proper to one of the smart objects, and each associated with the customisation data proper to this object.

According to another particular feature, the stage for establishing communication links is preceded by a stage for bringing together the connecting heads and the smart objects arranged on the portable support, with the connecting heads each being positioned opposite to one of the portable objects.

According to another particular feature, the stage for the locking of each smart object is followed by a stage for storage in a table, associating at least one positioning coordinate of each of the smart objects on the support with a reference to the customisation data transferred by the connecting head in communication with the object, the table being stored with an identifier of the associated support or directly stored in a chip incorporated into the support.

According to another particular feature, the stage for the locking of each smart object, is followed by a stage to control cut-off of the communication links, by means of the module for controlling the said electronic encoding device, by separation of the connecting heads and the smart objects arranged on the portable support.

According to another particular feature, the locking stage includes a transmission, to the control module, by each electronic encoding device of a multiplicity of electronic coding devices each controlling one or more separate connecting heads, of a message indicating the end of customisation, with the stage to control the cut-off of the communication links being executed after the reception by all of the electronic coding devices of the messages indicating the end of customisation.

According to another particular feature, the stage for establishing communication links is preceded by:
a feed stage, via a first manipulating arm that is controlled by the control module, bringing the portable support from an input store to a drive device,
a stage for advancement of the support placed on the drive device controlled by the control module, to a position that is determined according to a position indicator of the support placed opposite to the connecting heads, followed by:
the said stage for bringing together the support of the smart objects and the connecting heads, controlled by the control module.

According to another particular feature, the stage for cut-off of the communication links is followed by:
a stage for advancement of the drive device bringing the portable support up to an output store,
a stage for removal of the portable support to the output store, by a second manipulating arm, controlled by the control module.

According to another particular feature, the stage for establishing the communication links is preceded by a stage for the loading, into the said electronic encoding device, of at least the communication protocol, which is determined in accordance with the type of smart objects, or the operating system of the smart objects, or a configuration application.

According to another particular feature, the stage for the transfer of customisation data is preceded by a stage for the loading of the operating system or of the configuration application into the memory of the smart objects.

According to another particular feature, the stage for establishing the communication links is preceded by a stage for the loading of encrypted secure data into the said electronic encoding device, and for decryption by a security module that includes the second keys, and which communicates directly with the said electronic device, where these secure data include the customisation data associated with the second keys, with the decrypted customisation data relating to one of the second keys being positioned, in a separate memory space of the said electronic encoding device, each feeding into a software communication and management interface of a connecting head to one of the smart objects.

According to another particular feature, the stage for establishing communication links is preceded by a stage for relative movement of each of the contact-type connecting heads, in relation to contact strips of the smart object associated with each connecting head.

According to another particular feature, the stage for transfer of the customisation data includes several offset transfer initialisations associated with customisation data of specified and different volume, these transfers being offset in time, and in principle starting according to the magnitude of their respective volumes, so as to finish at the same time.

Another objective of this present invention is to propose a customisation system that allows an increase in the capacity for the electronic customisation of smart objects, but without increasing its dimensions and its bulk.

This objective is attained by virtue of a system for the customisation of smart objects that includes at least one module for controlling at least one customisation station, with the control module being fitted with at least one processing component and a storage component, where the customisation station includes communication heads that are controlled in accordance with at least one communication protocol determined by at least one electronic encoding device in communication with the control module,

characterised in that the customisation station includes a device for holding a portable support fitted with a multiplicity of housings that each includes one of the marked and identified smart objects,

where the station includes communication heads with as many smart object as there are housings in the support, with each communication head being positioned opposite to one of the smart objects of the support held by the holding device,

with the said encoding device storing at least one first key for unlocking the smart objects, and

with each communication head being fed with the contents of at least one memory area of the said encoding device, which includes secured data proper to each marked and identified smart object, and with these secured data being addressed to at least one memory zone of the chip, and with the secured data including at least customisation data associated with a second locking key.

According to another particular feature, the system includes a device for raising the support, controlled in accordance with a command for bringing together or moving apart the communication heads and the smart objects, so as to establish or break off the communication links between the communication heads and their associated smart objects.

According to another particular feature, the system includes, in memory, a positioning file associating each communication head with at least one positioning coordinate of one of the smart objects on the support in communication with this head, with the system being arranged so as to produce a table associating at least one positioning coordinate of each of the smart objects on the support with a reference to the customisation data to be transferred by the communication head into the smart object, this table being stored with an identifier of the associated support, or stored directly in a chip incorporated into the support.

According to another particular feature, the system includes a station for optical reading of the identifier recorded on the support, or a station for contactless reading from, or writing to, the chip incorporated into the portable support.

According to another particular feature, the connecting heads form part of a single-block assembly that is interchangeable according to the type of supports of the smart objects to be personalised, with this interchangeable assembly being associated with its positioning file, associating each communication head with its positioning coordinate for one of the smart objects on the support in communication with this head.

According to another particular feature, with the smart objects each including communication contact pins for establishing communication, the communication contact heads each includes conducting posts mounted on springs, in order to press the conducting posts against the conducting pins of the associated smart object when brought forward and transmitting, in addition to the information to be transferred, a power-supply or programming potential and a synchronising clock signal.

According to another particular feature, the communication heads are mobile laterally, and are each associated with a repositioning finger that moves the head laterally, with the finger being inserted into a housing of the support at a position determined in relation to the housing of the associated smart object.

According to another particular feature, the smart objects each includes a communication radiofrequency antenna, and the communication heads each includes a radiofrequency antenna operating at short distance when brought forward.

According to another particular feature, the control module sends, to the said electronic encoding device, at least one command for simultaneous unlocking of the smart objects, by means of the first key.

According to another particular feature, the system includes an input store supplying at least the said portable support positioned by a first manipulating arm on a device that brings it to the customisation station, with the position of the portable support in the customisation station being determined by a position indicator in communication with the control module, and with the drive device bringing the support, on leaving the customisation station, toward an output store, with the support being positioned in the output store by a second manipulating arm.

According to another particular feature, the smart objects include, at least in one component, a data processing device and a non-volatile memory incorporating an operating system or a configuration application, with the control module storing a multiplicity of communication protocols that can be loaded into the said electronic device, at least one of these protocols being compatible with the smart objects or their operating system or their configuration application.

According to another particular feature, the system includes a camera in communication with the control module, in which the data produced are representative of at least one image of the smart objects on their support, are analysed by means of image processing that has been designed for the detection, where appropriate, of one or more empty housings in the support and interruption of the customisation corresponding to the housings concerned.

The invention, its characteristics and its advantages will appear more clearly on reading the description that follows, and which is given with reference to the figures, in turn presented by way of a non-limiting example, and referenced below:

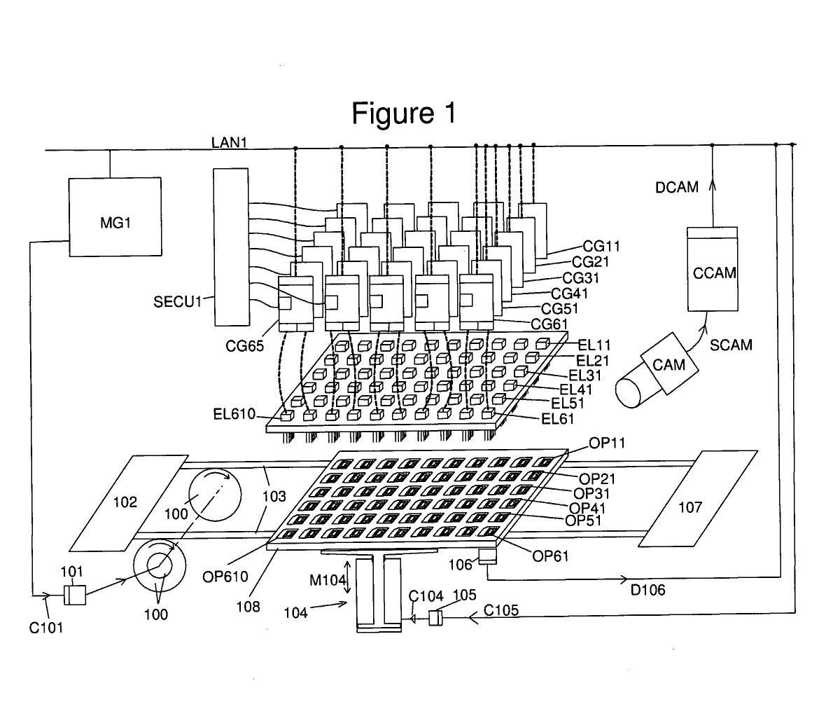

FIG. 1 represents an example of a customisation system according to the invention;

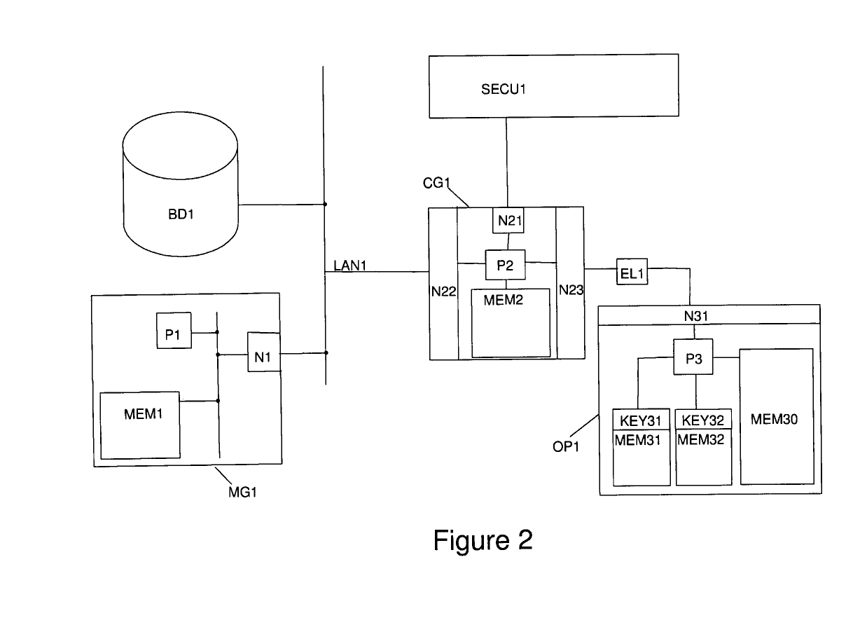

FIG. 2 represents a schematic example of a customisation system according to the invention;

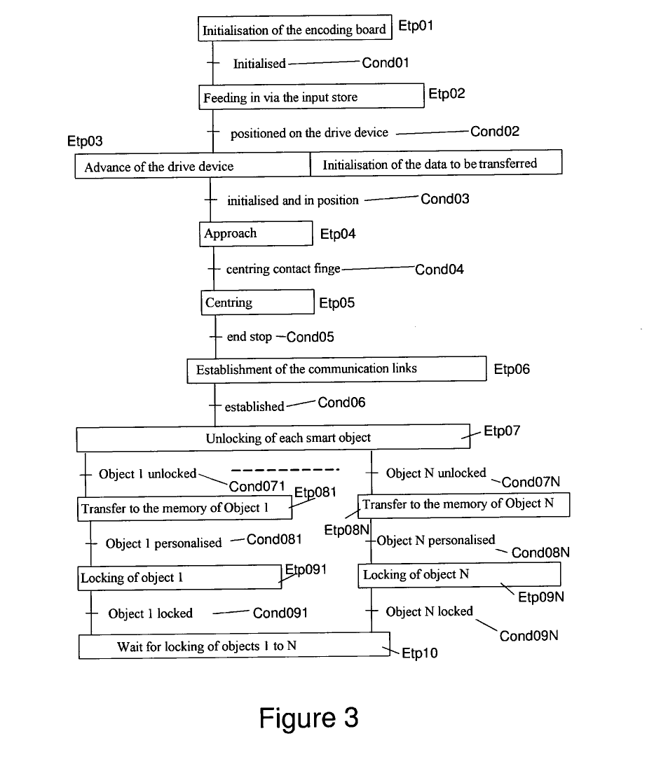

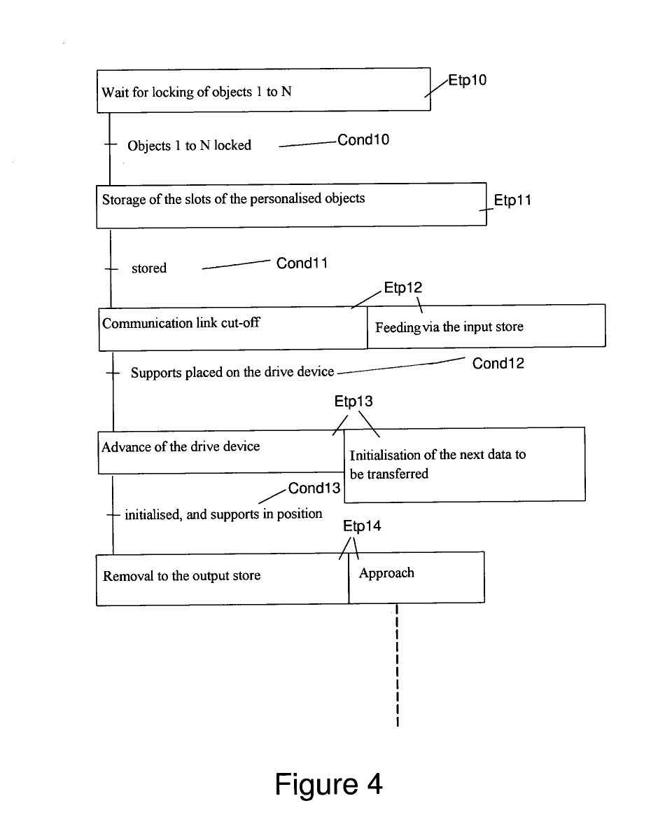

FIGS. 3 and 4 represent an example of a customisation method according to the invention,

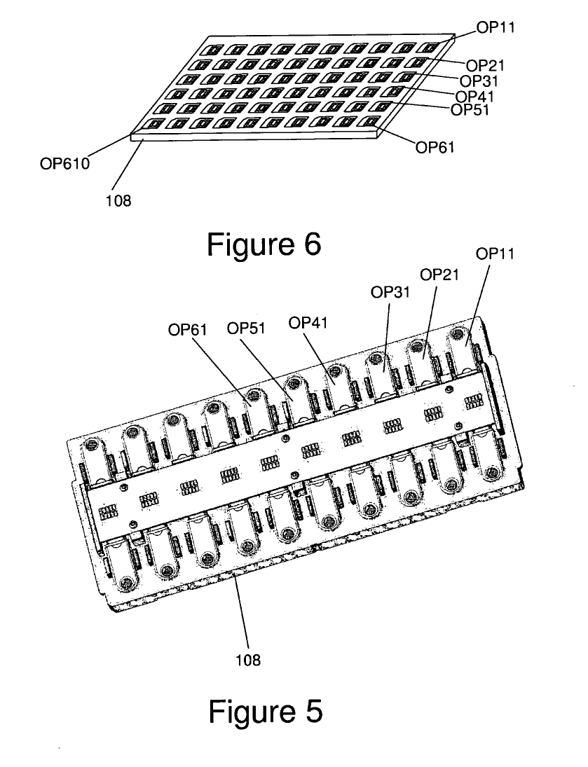

FIGS. 5 and 6 represent examples of a tray supporting smart objects.

The invention will now be described with reference to the aforementioned figures. The customisation machines can be used to write, into the memory of smart objects, data relating to a use of the object or an application executed by the object in its environment. In particular, data proper to the carrier of the object, rendering the object unique, can be written into memory of the smart object.

The electronically customisable objects can take many forms according to their type of use. As represented in FIG. 2, a smart object (OP1) includes a hardware and software communication interface (N31), communicating with a processing component (P3) inside the smart object. In a manner that is not limiting, the hardware communication interface includes pads for communication by contact or pins for communication by contact, or a contactless communication radiofrequency antenna. The smart object can also include others types of hardware communication interface, with or without contact.

The dialogue between the smart object and its external environment is handled in particular by the processing component (P3) of the smart object. The smart object includes several memory zones (MEM31, MEM32, MEM30), which contain, for example, an operating system or a configuration application or an application for communicating with its environment, or indeed confidential data such as, for example, a personal identification number, also known as a PIN. In a manner that is not limiting, the memories can be protected on read or on write. Protection against writing to memory can be used, for example, to prevent changes to the way that it interacts with its environment. Protection against reading and against writing, for example, prevents access to a secret code or reading from confidential data. A memory area that includes a confidential code is in fact a secured and secret zone that, for example, is not indicated automatically by the processing component (P3) and to which access is also prevented by a locking or encryption key (KEY31, KEY32). Data representing certificates or signatures can also be protected on read or on write. Access to certain multimedia content can also be prevented in the case, for example, of multimedia content of agents of the Digital Right Management (DRM) type. The smart objects, each equipped with a processing component or an access controller to memory zones or to data that are encrypted and protected on read or on write, can be used to perform complex operations, and are known as intelligent smart objects for example.

The customisation is effected for example, by the communication element, with or without contact, with the processing component (P3) executing a configuration application. Non-limiting examples of intelligent smart objects are as follows for example:
plug-in Subscriber Identity Modules (SIMs) used in mobile telephones,
smart objects used in bank applications for money withdrawal or payment,
intelligent USB keys, which include protected memory zones and, for example, allowing access to a network or the operation of a specified application on a work station,
intelligent objects in the form of Secure Digital (SD) or miniSD or microSD cards, containing a processing component or memory zones that are protected on read or on write,
intelligent objects in the form of Multimedia Memory cards (MMC) or Reduced Size MMC cards (RS-MMC) or Memory Sticks containing a processing component or memory zones that are protected on read or on write.
supported contactless keys, also called “key fobs”, which includes an application for payment or ticketing for example or control of access to reserved zones,
components in the Quad Flat No-Lead (QFN) format or in the Ball Grid Arrays (BGA) format or in the Small Outline Packages (SOP) format used for Machine To Machine (M2M) applications, for example.

A set of smart objects, of small size, is generally stored on a suitable support, such as a tray. On its extended upper side, for example, a tray includes a multiplicity of individual communicating smart objects arranged alongside each other and laid out in housings on this face of the tray. In a manner that is not limiting, the side of the tray accommodating the individual smart objects is equipped with bosses or indentations for lateral retention of the communicating smart objects. The housings for the smart objects can also include a flange that presses onto the object, forming a hole through the tray, this hole being used to reach the bottom side of the smart object. The objects can also be gripped by the lateral edges of the housing to hold the object on the support. The support also includes an edge of particular shape, or projecting elements or holes, that are used in the manipulating action of the holding or driving devices in a customisation machine. The tray can also be stored in a storage structure, and held by its edges for example.

In a manner that is not limiting, a support for smart objects can include a locating element such as a hole or a projecting element, placed alongside the housing, at a given distance and in a given direction in relation to the support. In this way, the hole or the projecting element can act as a positioning locator for an element connecting to the smart object for example. Each housing is associated with its positioning locator for example. A positioning locator can be used in particular for electrical contacts through pads on the smart object, in the case where the small size of the pads call for precise positioning of the contact points of the connecting element. In a manner that is not limiting, the positioning locator can also indicate the orientation of the contact pads of a smart object.

The support can also include a radiofrequency chip, embedded in the support, which is used for identification of the support or for the recording of information in the memory of the chip. The support can also include an identification mark recorded on the support, such as an alphanumeric code or a barcode or a code that has been engraved or etched in relief. In this way, the portable support can be identified when transported to or stored in different places. The complete identification of the support is effected, for example, by accessing a database and comparing the identifiers of the smart objects to an identifier in the base, according to their position on the tray, the operations effected, or the saved data. In a manner that is not limiting, coordinates for describing the position of the tray, consisting of an abscissa and an ordinate or a line number and a column number or a position number, in a given agreed order of the objects on the support. These coordinates, used to describe a position of the object on the support, are not limiting however, and can also include an orientation of the contact strips or the relative positions of two objects.

In a manner that is not limiting, the contact-type communicating smart objects are arranged with their terminals or their contact pads upwards, as represented in FIG. 6, in order to be accessible, or these smart objects are connected to contact elements on the support, as represented in FIG. 5, in contact with remote contact elements arranged on the upper face of the support. Intelligent Universal Serial Bus (USB) components are positioned flat for example, and inserted in vertical connection slots, with electrical contact pads on an upper surface of the support being connected electrically to the connection slots. In particular, upward facing contact pads can be contacted by contact points mounted on springs belonging to an interchangeable flat assembly of a customisation station.

The number of smart objects on the support depends, for example, on the size of the smart objects and the size of the tray. In a manner that is not limiting, a tray can contain between 15 and 200 smart objects. The smart objects are arranged, for example, on the upper face of the support, alongside each other, in the form of a matrix with a given number of lines by a given number of columns. The smart objects can also be arranged in several lines with an offset every other line. A contactless smart object, communicating by radiofrequency waves, is thus surrounded by a circular free zone reserved for its own communication.

The customisation machine includes, for example, a control module (MG1), which includes a processing component (P1) communicating with a storage component (MEM1) and an interface module (N1) to a local network (LAN1), connected, for example, to a database (BD1) and to one or more encoding devices (CG1). Encrypted customisation data or unencrypted data to be loaded into the smart objects are, for example, copied from the database and formatted by the control module for transmission to the encoding devices.

In order to be able to transmit data to the communication objects, the control module executes, for example, a preliminary stage (Etp01) for the loading into the electronic coding device or devices of a program for managing the communication protocol to the smart objects. An encoding device (CG1), constructed on a printed circuit board for example, includes, for example, an interface module (N22) for communication with the control module (MG1), via which the control module (MG1) loads data into the memory (MEM2) of the encoding device (CG1). The execution, by the processor (P2) of the encoding device, of the program for managing the communication protocol to the smart objects, is used, for example, to communicate via an interface module (N23) for communication with one or more smart objects (OP1) via linking elements (EL1). In fact, the communication protocol depends not only on the nature of the smart object, its operating system, or its configuration application, but also on the applications or codes stored in memory. The encoding device (CG1) must in fact communicate simultaneously via an interface module (N21) to a safety module (SECU1), of the Hardware Security Module (HSM) type for example. The safety module (SECU1) is connected by direct links to the encoding devices (CG1). This security module includes the locking keys for example, called customisation keys for example. These keys are programs using encryption algorithms, for example, which are employed to block or unblock access to given memory zones in the chip. The security module, which is accessed during the recording of confidential data in the memory of the smart object for example, such as a PIN for example, is used to prevent unauthorised access to the customisation keys or to other confidential data, since these data do not transit via the local network or are not copied from the memory of the control system. After the initialisation (Cond01) of the encoding devices (CG11, CG21, CG31, CG41, CG51, CG61, CG65), the customisation machine is then in a position to process the trays supporting the smart objects to be personalised.

A set of several trays (108) is placed in a store (102) at the entry to the customisation machine for example. The trays are arranged one above the other for example, placed on the structure of the input store (102), ready to be grasped. The communicating smart objects, at the entry to the customisation machine, are set electronically to a locked state by a key for example, called a transportation key for example. This transportation key is recorded by the manufacturer of the smart objects for example. The smart objects accommodated on their transportation tray, are thus placed directly, on their tray, into the customisation machine. Thus the operator directly loads the trays into the input store, without having to handle the smart objects. Such handling, which can damage the portable smart objects or lead to incorrect positioning in the customisation machine or to dropping and loss if the smart objects, is thus avoided. The handling process is thus facilitated.

At the input store, a tray (108) is grasped (Etp02) manually or automatically by an automated manipulating arm, with the tray then being placed (Cond02) onto a transportation path. The transportation path includes a guidance structure, for example, together with support (103) and drive (100) elements to bring each tray (108) to an electronic customisation station. The tray (108) is placed onto mobile strips (103) for example, moving on motor-driven rollers (100). The drive motor of these rollers (100) is controlled by an electronic power unit (101) for example, which is controlled by a control module (MG1). The control module (MG1) controlling the stopping or advance stopping or advance of the motor, sends a command (C101) for example to stop or advance the support of the smart objects along the transportation path.

The control module (MG1) controls (Etp03) the advance of the drive device for example, at the same time as initialisation of the data residing in the encoding devices to be transferred. In a manner that is not limiting, a position sensor (106) produces data (D106) which may or may not indicate the position of the tray with its housings facing the connecting heads, in the customisation station. The element for detecting the position of the tray includes, for example, a light beam, such as a laser beam for example, interacting with a light sensor to detect whether the tray is cutting the light beam or not. When the position of the tray, with its housings facing the connecting heads, is detected, the control module (MG1) sends a command (C101) for example, to stop the tray on the transfer path. The position indicator sensor will be adjusted or moved for example, during a change of the type of tray to be processed, in order to match the customisation machine to the different types of tray.

In addition, the control module (MG1) controls, in parallel for example, the setting up of the memories of the encoding devices so as to prepare for customisation of all the smart objects on a tray. In a manner that is not limiting, the encoding device or devices are configured at the start of a series of trays for a given type of tray with its smart objects of a given type. Then, for each tray to be processed, the encoding devices are configured for the locking or unlocking key or keys, and for the customisation data to be transmitted for the customisation of another tray with its customisable smart objects.

After (cond03) preparation of the encoding devices and positioning of the tray supporting the smart objects in the customisation station, the control module executes a stage (Etp04) for bringing together of the tray and the connecting heads, for example.

The customisation station includes a mobile elevation element (104), for example, such as a push tray placed at the end of a jack for example, bringing the smart objects (OP11, OP21, OP31, OP41, OP51, OP61, OP610) to be personalised so that each is connected to a linking element (EL11, EL21, EL31, EL41, EL51, EL61, EL610), with or without contact, of the customisation station. The activated mobile elevation element (104), by its action, effects a relative movement (M104) of the tray supporting the smart objects toward the linking elements of the customisation station. The push tray is fitted with projecting elements or holes for example, that mate with elements of complementary shape arranged under the portable support of the smart objects, so as to hold the support. The relative movement is effected by the jack whose shaft is commanded to push out, for example. The element for bringing the components together passes between the belts (103) that drive the transportation path for example, raising the tray (108) supporting the smart objects, above the belts. An actuator (105) transmits a command (C104) for example, for activation of the jack, with this actuator (105) also receiving a corresponding command (C105), sent by the control module (MG1).

In a manner that is not limiting, a camera (CAM) positioned above the tray (108) for holding the smart objects, captures one or more images of the top of the tray. The camera (CAM) is offset laterally for example, in relation to the linking elements and to the tray (108), with the linking elements, which may be with or without contact, in the electronic customisation station each being arranged directly above a smart object. In a manner that is not limiting, the camera is connected to an interface tray (CCAM) that communicates with the central control module (MG1). The captured images are transmitted, for example, in the form of signals (SCAM) to the interface tray, which produces data (DCAM) representing the captured images. Data in digital format can also be produced directly by a digital camera. These data (DCAM) are transmitted to the control module for example, to be analysed and to detect the presence or absence of a smart object in each of the housings of the support, such as the transportation tray for example. The absence of a smart object gives rise to stopping of the communication for example, by the connecting element associated with this housing.

All of the linking or connecting head elements (EL11, EL21, EL31, EL41, EL51, EL61, EL610), can be implemented, in a manner that is not limiting, by a single-block device. A set of connecting heads can thus be changed in one single operation. All of the connecting heads will be matched for example, to a support tray and to a type of smart objects. Thus in order to adapt the customisation machine, the operator simply changes this single-block connecting head assembly. The connecting heads will be positioned like the positioning of the housings in the trays, or according to the position and the orientation of the contact strips, and each head will be connected to an encoding device by a wiring harness for example. The single-block connecting head assembly is made in the form of a board for example, held by its edges in the customisation machine. This board includes, on its lower face for example, the connecting heads connected by electrical connectors arranged on the upper face of the board. The fixing of the board can be effected, in a manner that is not limiting, by crimping, clipping or screwing, and will preferably be removable and interchangeable. The customisation station thus has a simple mechanical action, and can be adapted easily to several types of board. Maintenance is therefore facilitated by its simple mechanical structure, and the reliability of the machine is improved.

In a manner that is not limiting, the bringing together ends (cond04) at an end-stop position of the raising device, or an intermediate centring stage (Etp05) is executed. The advance of the tray is slowed for example, in order to allow centring of each head in relation to a positioning locator placed on the tray. This locator is a hole for example, in which a finger connected to the head is placed. Each head is positioned laterally for example, so that it ends up exactly facing the linking elements on the smart object, such as the contact points pressed against metal pads on the smart object, for example.

After the complete movement upwards of the tray (cond05) for example, the linking elements are connected firstly to a communicating portable smart object and secondly to their encoding device. A stage (Ept06) for establishing communication is then executed for example. The establishment of the communication includes, for example, a simple application of voltage or a measurement of impedance or current, confirming the presence of a functional smart object. The empty housings detected are not tested for example, and the non-functional components detected are indicated to the control module (MG1), for example. Each communication interface associated with a connecting head corresponds in fact to a position on the tray, and enables one to indicate a smart object by its position on the tray. A file corresponding to each set of connecting heads is, supplied to the control module by the database for example, with this file taking including the method of location of the smart objects on their support, and the description of each smart object.

Whatever the linking elements, an encoding device is thus able to converse with a smart object via a software and hardware communication interface. In a manner that is not limiting, the linking elements can be implemented in the form of metal contact points making contact with metal communicating pads on the smart object. The contact points are each pushed toward the smart objects for example, by an elastic element such as a spring, holding the metal point pressed onto the contact pad.

The linking elements, which include an antenna for example, can also be contactless communication elements using radiofrequency waves. The radiofrequency antenna, created in the form of a flat winding or with a central vertical axis for example, can thus be used for the transmission reception of data with a communicating smart object by radiofrequency waves, like a communicating and intelligent key ring.

The maximum number of customisable smart objects arranged on the support, such as a transportation tray, corresponds to the number of connecting heads, for example. In a manner that is not limiting, each electronic encoding device runs one or more communication interface, each of which includes a connecting head. The encoding devices can be multitasking or controlled in parallel. In this way, the communication can be established, simultaneously and in parallel, with each of the functional smart objects arranged on the tray. Since the connecting heads each has an identifier, and corresponds to a given housing position on the transportation tray, each smart object, as well as its stored data, can be matched up with its position in an identified tray.

After establishment of the communication (Cond06) with the smart objects (OP11, OP21, OP31, OP41, OP51, OP61, OP610) on the tray (108), a stage (Etp07) for the unlocking of all the smart objects is executed, in a manner that is not limiting. The control module sends, to the encoding devices for example, a command for simultaneous unlocking of the smart objects on the tray. A first unlocking key will, for example, have been previously loaded into the encoding devices. This first key is a transportation key that is common to all the objects on the tray for example. The transport key is used to electronically lock the smart objects to be personalised, during transportation. The key in fact is an encryption algorithm, with this algorithm being validated by a dialogue between an encoding device and a smart object. In a manner that is not limiting, a transportation key proper to each smart object can also be used for this unlocking.

After the unlocking of each object, all objects are personalised in parallel. The rate of customisation is thus greatly improved in relation to a machine that is working in series. For example, with the customisation of one smart object about every 10 seconds, and passage via the customisation station that takes a total of 20 seconds, then the customisation of trays with 60 smart objects produces a yield of about 10,000 smart objects personalised per hour.

The unlocking (Cond071, Con07N) of an object is followed by a stage (Etp081, Etp08N) for transferring the data into the memory of the smart object. In a manner that is not limiting, this transfer includes, for example, a pre-customisation step that includes the transfer into the memory of the object to be personalised of data that is common to all the smart objects. These common data concern a common application for example, and are loaded beforehand into the encoding devices by the control module. In a manner that is not limiting, the database (BD1) connected to the local network (LAN1) supplies these data to the control module in a form that may be encrypted or not. The encrypted data are decrypted by means of the security module (SECU1) for example. The unencrypted or decrypted data to be transmitted, are placed in a transmit buffer for example, corresponding to a separate interface for communication with the smart object. All of the encoding devices have a memory that is organised into several separate compartments, for example, for each communication interface to a smart object. Each of these separate memory zones for the feeding of a communication interface to a smart object is associated in particular with a separate head for linking and to a given position on the support, such as a transportation tray, for example.

The transfer of data into the memory of the unlocked smart object includes customisation of the smart object, meaning the transfer of data proper to the smart object or proper to its carrier, which render this object unique. Encrypted customisation data are loaded beforehand into the memory of the encoding devices, and then decrypted to be placed in each transmit buffer associated with their communication interface. In a manner that is not limiting, decryption is effected simultaneously for all of the encoding devices. Decryption is performed in particular by algorithms that are stored in the security module (SECU1). The customisation data are recorded, at least in part, in so-called secret zones on the chip.

After (Cond081, Cond08N) the transfer of the customisation data into memory of the smart object, each smart object is locked (Etp091, Etp09N) by a second locking key proper to each object, and supplied by the security module, in a manner that is not limiting. The second key is called the customisation key for example, and the locking corresponding can be unblocked with a code that is held by the carrier of the object for example. Locking can also prevent any alteration of the protected memory zones.

The control module performs surveillance, during a wait stage (Etp10) for example, during the locking of all the smart objects. Since the customisation data are proper to each smart object, then the electronic customisation time can differ from one smart object to the next. The encoding devices each send to the control module a signal of the end of customisation for each of the smart objects handled, for example.

After (Cond10) locking of all of the smart objects, a stage (Etp11) for the storage of an archive file, which includes the locations of the personalised objects is executed, for example. An identifier of the user of each chip, associated with a position, on the support of the smart objects, of each smart object corresponding to this identifier, is stored by the control module (MG1), for example. The control module can also store data representing the stored data in each chip, associated with the position of each smart object on the object support.

In addition, the tray is associated with its smart objects referenced in the archive file, by storing an identifier of the tray in the archive file, or by storing the archive file in a chip built into the tray. In this way, the tray can continue to be personalised in another machine, in relation to the customisations already effected. The objects on the tray can also be selected separately by referring to the archive file associated with the tray, to be separated by the tray and sent separately with identification documents or the authentication codes, for example.

After storage of the locations of the personalised objects (Cond11) on the tray, a following stage (Etp12) to cut-off of the communication links is executed for example. A separation command is sent by the control module for example, to the raising device (104) or to another device for moving the support. In a manner that is not limiting, the feeding in of a new tray, coming from the input store, is effected in parallel, for the processing of the next tray.

After (Cond12) the lowering of the support tray with its personalised smart objects, and positioning of a new tray on the drive device, a following stage (Etp13) for advancement of the drive device is then executed, for example. In a manner that is not limiting, the control module also configures the electronic coding devices for the following customisation. In a manner that is not limiting, the prior configuration or loading of the encoding devices are effected and controlled simultaneously for all of the encoding devices. After its electronic customisation, each tray (108) with its smart objects personalised, is then transported along the transportation path up to an output store (107). Secondly, the new tray to be personalised is brought up to the customisation station, for example.

In a manner that is not limiting, when the trays are in position, with one in the customisation station and the other before the output store, and where the encoding devices have been loaded and configured (Cond13) beforehand, a next stage (Etp14) is executed for example, during which the personalised tray is removed to the output store, and during which a new approach operation is ordered by the control module. The new tray to be personalised is personalised as described above for example. Secondly the personalised tray is positioned in the output store (107), manually or automatically, by another automated manipulating arm.

The customisation machine is not limited to electronic customisation, and can also perform graphical customisation in a graphical customisation station. One or more other customisation stations can be positioned on the transportation path, between the input store (102) and the output store (107), so as to perform one or more additional customisations.

It will be obvious to those who are well versed in the art that this present invention allows implementation in many other specific forms without moving outside the area of application of the invention as claimed. As a consequence, these present embodiments must be considered as illustrations only, but can be modified within the area defined by the scope of attached claims.

1. A customisation method, wherein it includes at least:
a stage for location or marking and identification of each of a multiplicity of smart objects received by a support;
a stage for centring each smart object in the support;
a stage for establishing communication links between a multiplicity of smart objects received by a support that is held in position in relation to a multiplicity of controlled connecting heads, according to at least one communication protocol determined by at least one electronic encoding device; and
a stage for the parallel transfer into the memory of each of the multiplicity of smart objects, in accordance with the associated location or marking and identification, of customisation data proper to each of the smart objects, where these customisation data come from the memory of the said electronic encoding device and are transferred into at least one memory zone of each smart object.

2. A customisation method according to claim 1, wherein the stage for the parallel transfer into the memory of each of the multiplicity of smart objects is preceded by a stage for simultaneous unlocking device, by means of at least one first key.

3. A customisation method according to claim 1, wherein the stage for the parallel transfer into the memory of each of the multiplicity of smart objects is followed by a stage for the locking of each smart object by the said electronic encoding device, by means of second keys, each proper to one of the smart objects, and each associated with the customisation data proper to this object.

4. A customisation method according to claim 1, wherein the stage for establishing communication links is preceded by a stage for bringing together the connecting heads and the smart objects arranged on the portable support, with the connecting heads each being positioned opposite to one of the portable objects.

5. A customisation method according to claim 1, wherein the stage for the locking of each smart object is followed by a stage for storage in a table, associating at least one positioning coordinate of each of the smart objects on the support with a reference to the customisation data transferred by the connecting head in communication with the object, the table being stored with an identifier of the associated support or directly stored in a chip incorporated into the support.

6. A customisation method according to claim 1, wherein the stage for the locking of each smart object is followed by a stage to control the cut-off of the communication links, by means of a module for controlling the said electronic encoding device, by separation of the connecting heads and the smart objects arranged on the portable support.

7. A customisation method according to claim 6, wherein the locking stage includes a transmission, to the control module, by each electronic encoding device of a multiplicity of electronic coding devices each controlling one or more separate connecting heads, of a message indicating the end of customisation, with the stage to control the cut-off of the communication links being executed after reception by all of the electronic coding devices of the messages indicating the end of customisation.

8. A customisation method according to claim 6, wherein the stage for establishing communication links is preceded by:
a feeding stage, via a first manipulating arm that is controlled by the control module, bringing the portable support from an input store to a drive device,
a stage for advancement of the support placed on the drive device controlled by the control module, to a position that is determined according to a position indicator of the support placed opposite to the connecting heads, followed by:
the said stage for bringing together the support of the smart objects and the connecting heads, controlled by the control module.

9. A customisation method according to claim 8, wherein the stage for cut-off of the communication links is followed by:
a stage for advancement of the drive device bringing the portable support up to an output store,—a stage for removal of the portable support to the output store, by a second manipulating arm, controlled by the control module.

10. A customisation method according to claim 1, wherein the stage for establishing communication links is preceded by a stage for the loading, into the said electronic encoding device, of at least the communication protocol which is determined in accordance with the type of smart objects or the operating system of the smart objects, or a configuration application.

11. A customisation method according to claim 10, wherein the stage for the transfer of customisation data is preceded by a stage for the loading of the operating system or the configuration application into the memory of the smart objects.

12. A customisation method according to claim 1, wherein the stage for establishing the communication links is preceded by a stage for the loading of encrypted secure data into the said electronic encoding device, and for decryption by a security module that includes the second keys, and which communicates directly with the said electronic encoding device, where these secure data include the customisation data associated with the second keys, with the decrypted customisation data relating to one of the second keys being positioned in a separate memory space of the said electronic encoding device, each feeding into a software communication and management interface of a connecting head to one of the smart objects.

13. A customisation method according to claim 1, wherein the stage for establishing communication links is preceded by a stage for relative movement of each of the contact-type connecting heads in relation to contact strips of the smart object associated with each connecting head.

14. A customisation method according to claim 1, wherein the stage for transfer of the customisation data includes several offset transfer initialisations associated with customisation data of specified and different volume, these transfers being offset in time, and in principle starting according to the magnitude of their respective volumes, so as to finish at the same time.

15. A system for the customisation of smart objects, which includes at least one module for controlling at least one customisation station, with the control module being fitted with at least one processing component and one storage component, where the customisation station includes communication heads that are controlled in accordance with at least one communication protocol determined by at least one electronic encoding device in communication with the control module, wherein the customisation station includes a device for holding a portable support fitted with a multiplicity of housings that each includes one of the marked and identified smart objects, where the station includes communication heads with as many smart object as there are housings in the support, with each communication head being positioned opposite to one of the smart objects of the support held by the holding device, with the said encoding device storing at least one first key for unlocking the smart objects, and with each communication head being fed with the contents of at least one memory area of the said encoding device, which includes secured data proper to each marked and identified smart object, and with these secured data being addressed to at least one memory zone of the chip, and with the secured data includes at least customisation data associated with a second locking key.

16. A customisation system according to claim 15, wherein it includes a device for raising the support, controlled in accordance with a command for bringing together or moving apart the communication heads and the smart objects, so as to establish or break off communication links between the communication heads and their associated smart objects.

17. A customisation system according to claim 15, wherein it includes, in memory, a positioning file associating each communication head with at least one positioning coordinate of one of the smart objects on the support in communication with this head, with the system being arranged so as to produce a table associating at least one positioning coordinate of each of the smart objects on the support with a reference to the customisation data to be transferred by the communication head into the smart object, this table being stored with an identifier of the associated support or stored directly in a chip incorporated into the support.

18. A customisation system according to claim 17, wherein it includes a station for optical reading of the identifier recorded on the support or a station for contactless reading from, or writing to, the chip incorporated into the portable support.

19. A customisation system according to claim 17, wherein the connection heads form part of a single-block assembly that is interchangeable according to the type of supports of the smart objects to be personalised, with this interchangeable assembly being associated with its positioning file, associating each communication head with its positioning coordinate of one of the smart objects on the support in communication with this head.

20. A customisation system according to claim 15, wherein the smart objects each including communication contact pins for establishing communication, communication contact heads, each includes conducting posts mounted on springs in order to press the conducting posts against the conducting pins of the associated smart object when brought forward, and transmitting, in addition to the information to be transferred, a power-supply or programming potential and a synchronising clock signal.

21. A customisation system according to claim 20, wherein the communication heads are mobile laterally, and are each associated with a repositioning finger that moves the head laterally, with the finger being inserted into a housing of the support at a position that is determined in relation to the housing of the associated smart object.

22. A customisation system according to claim 15, wherein the smart objects each includes a communication radiofrequency antenna, and the communication heads each includes a radiofrequency antenna operating at short distance when brought forward.

23. A customisation system according to claim 15, wherein the control module sends to the said electronic encoding device at least one command for simultaneous unlocking of the smart objects by means of the first key.

24. A customisation system according to claim 15, wherein it includes an input store supplying at least the said portable support positioned by a first manipulating arm on a device that brings it to the customisation station, with the position of the portable support in the customisation station being determined by a position indicator in communication with the control module, and with the drive device bringing the support, on leaving the customisation station, toward an output store, with the support being positioned in the output store by a second manipulating arm.

25. A customisation system according to claim 15, wherein the smart objects include at least in one component a data processing device and a non-volatile memory incorporating an operating system or a configuration application, with the control module storing a multiplicity of communication protocols that can be loaded into the said electronic device, at least one of these protocols being compatible with the smart objects or their operating system or their configuration application.

26. A customisation system according to claim 17, wherein it includes a camera in communication with the control module, in which the data produced are representative of at least one image of the smart objects on their support, are analysed by means of image processing that has been designed for the detection, where appropriate, of one or more empty housings in the support, and interruption of the customisation corresponding to the housing concerned.
